(19) United States
(12) Patent Application Publication
(10) Pub. No.: US 2026/0289783 A1
(43) Pub. Date: Sep. 24, 2026

(54) INFORMATION PROCESSING APPARATUS, METHOD, AND PROGRAM

(71) Applicant: FUJIFILM Corporation, Tokyo (JP)

(72) Inventors: Shinichi KOJIMA, Kanagawa (JP); Kazuma YOKOI, Kanagawa (JP); Isao TAKAHASHI, Kanagawa (JP)

(73) Assignee: FUJIFILM Corporation, Tokyo (JP)

(21) Appl. No.: 19/557,172

(22) Filed: Mar. 5, 2026

(30) Foreign Application Priority Data
Mar. 21, 2025 (JP) 2025-046990

(51) Int. Cl. G06T 7/00; G06V 10/22

(52) U.S. Cl. CPC G06T 7/0014; G06V 10/22; G06T 2207/10072

(57) ABSTRACT

A processor is configured to: display at least one tomographic image of a substance discrimination image including a plurality of tomographic images derived by substance discrimination; receive designation of a region of interest in the displayed tomographic image; extract an organ in which the region of interest is designated from the substance discrimination image; and derive a reference value for comparison with the region of interest in the extracted organ.

### CROSS-REFERENCE TO RELATED APPLICATION

The present application claims priority from Japanese Patent Application No. 2025-046990, filed on Mar. 21, 2025, the entire disclosure of which is incorporated herein by reference.

### BACKGROUND

### Technical Field

The present disclosure relates to an information processing apparatus, a method, and a program.

### Related Art

As a technique for effectively using information from X-ray groups having a plurality of energy distributions, photon counting computed tomography (PCCT) including a photon counting type detector that employs a photon counting method and dual energy (DE) CT are known.

In the PCCT and the DECT, since the absorption characteristics of radiation are different for each substance, a substance discrimination image in which substances included in the subject are discriminated can be obtained. In addition, for example, a substance discrimination image for each of two base substances set in advance, such as water and iodine, is acquired, and weighting calculation processing is performed using the two substance discrimination images, so that various images such as a virtual monochromatic image (VMI), an electron density image, an effective atomic number image, and a specific substance image (iodine map) can be acquired.

In addition, an image diagnosis using a scatter diagram in which the concentration of each base substance used for the substance discrimination is an axis and the pixel of the substance discrimination image output by the substance discrimination is plotted according to which concentration of the base substance it corresponds to is also performed.

The image diagnosis using the image acquired as described above is performed by displaying the image, designating a region of interest that is a candidate for an abnormal shadow by a doctor, designating a normal region in an organ in which the region of interest is designated as a reference region, and comparing the designated region of interest and reference region. Specifically, a method of plotting values of water and iodine in the region of interest and values of water and iodine in the reference region on a scatter diagram and determining whether the region of interest is benign or malignant based on a direction of the plot of the region of interest with respect to the plot of the reference region on the scatter diagram has been proposed.

As a method of extracting such a reference region, a method of acquiring a tomographic image including a desired organ of the subject, designating a plurality of points or regions by an operator using an input unit such as a mouse, and extracting the reference region based on a CT value in the vicinity of the designated point or the vicinity of the designated region has been proposed (see WO2007/145093A).

However, in the image diagnosis described above, the operator such as a doctor needs to designate the reference region in addition to the region of interest, so that the burden on the operator is high.

### SUMMARY OF THE INVENTION

The present disclosure has been made in view of the above circumstances, and an object of the present disclosure is to reduce a burden on an operator who designates a reference region in a case of performing image diagnosis.

According to the present disclosure, an information processing apparatus comprises a processor, and
the processor is configured to:
display at least one tomographic image of a substance discrimination image including a plurality of tomographic images derived by substance discrimination;
receive designation of a region of interest in the displayed tomographic image;
extract an organ in which the region of interest is designated from the substance discrimination image; and
derive a reference value for comparison with the region of interest in the extracted organ.

In the information processing apparatus according to the present disclosure, the processor may be configured to:
set a reference region in a region having the reference value in the plurality of tomographic images; and
display the tomographic image in which the reference region is set in a distinguishable manner from other regions.

In the information processing apparatus according to the present disclosure, the processor may be configured to:
determine whether an abnormality is included in the reference region by referring to at least one other substance discrimination image of a type different from the substance discrimination image; and
set the reference region excluding an abnormal region that includes the abnormality, in a case where the abnormality is determined to be included.

In the information processing apparatus according to the present disclosure, the processor may be configured to derive, as the reference value, any one of an average value of signal values in the extracted organ in the plurality of tomographic images, a mode value of the signal values, or an average value or a mode value in a maximum distribution in a case where the signal values in the organ are separated into a plurality of distributions.

In the information processing apparatus according to the present disclosure, the reference value may be a two-dimensional value defined by a signal value of a first substance and a signal value of a second substance that are subjected to the substance discrimination.

According to the present disclosure, an information processing method comprises: via a computer,
displaying at least one tomographic image of a substance discrimination image including a plurality of tomographic images derived by substance discrimination;
receiving designation of a region of interest in the displayed tomographic image;
extracting an organ in which the region of interest is designated from the substance discrimination image; and
deriving a reference value for comparison with the region of interest in the extracted organ.

According to the present disclosure, there is provided an information processing program causing a computer to execute:
a procedure of displaying at least one tomographic image of a substance discrimination image including a plurality of tomographic images derived by substance discrimination;
a procedure of receiving designation of a region of interest in the displayed tomographic image;
a procedure of extracting an organ in which the region of interest is designated from the substance discrimination image; and
a procedure of deriving a reference value for comparison with the region of interest in the extracted organ.

The technology of the present disclosure may be applied to a program product.

According to the present disclosure, a burden on an operator who designates a reference region in a case of performing image diagnosis is reduced.

### BRIEF DESCRIPTION OF THE DRAWINGS

FIG. 1 is a schematic configuration diagram of a medical image capturing system comprising an information processing apparatus according to an embodiment of the present disclosure.

FIG. 2 is a diagram showing a hardware configuration of the information processing apparatus according to the present embodiment.

FIG. 3 is a diagram showing a functional configuration of the information processing apparatus according to the present embodiment.

FIG. 4 is a diagram showing a display screen of a tomographic image.

FIG. 5 is a diagram showing a display screen of a tomographic image.

FIG. 6 is a diagram showing a histogram of a signal value of a virtual monochromatic image in an organ.

FIG. 7 is a diagram showing a display screen of a tomographic image.

FIG. 8 is a diagram showing a display screen of a tomographic image to which a mark is assigned to a reference region.

FIG. 9 is a diagram showing a scatter diagram in which a pixel value of a region of interest and a reference value are plotted.

FIG. 10 is a flowchart showing processing performed in the present embodiment.

### DETAILED DESCRIPTION

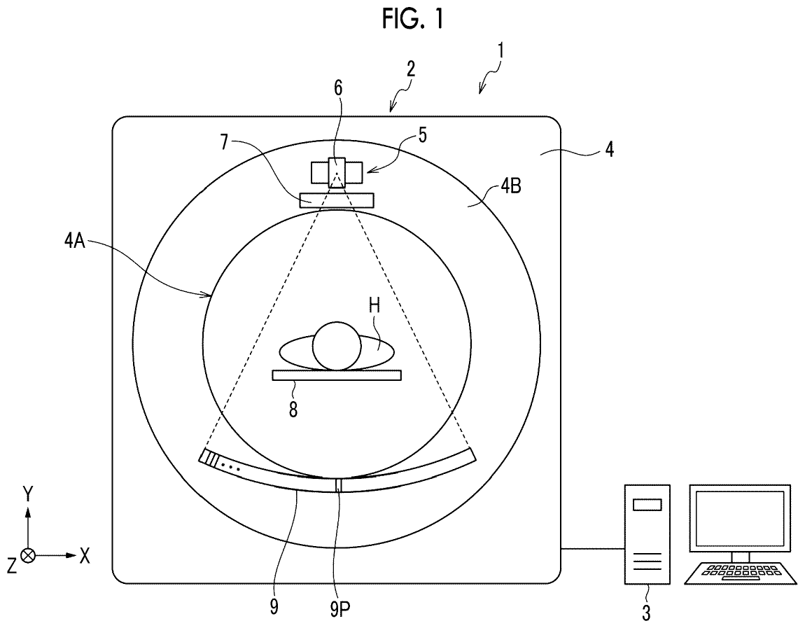

An embodiment of the present disclosure will be described in detail below with reference to the accompanying drawings. First, an example of a configuration of a medical image capturing system comprising an information processing apparatus of the present embodiment will be described. FIG. 1 is a schematic configuration diagram of the medical image capturing system comprising the information processing apparatus of the present embodiment.

A medical image capturing system 1 of the present embodiment comprises a CT apparatus 2 and a console 3, as shown in FIG. 1. The CT apparatus 2 comprises a gantry 4 and a patient table 8. In the following description, a horizontal direction in FIG. 1 is referred to as an X-axis, a vertical direction is referred to as a Y-axis, and a direction orthogonal to an XY plane is referred to as a Z-axis.

The gantry 4 has an opening portion 4A, and a subject H to be imaged is disposed within the opening portion 4A while being placed on the patient table 8. The gantry 4 and the patient table 8 are configured to move relative to each other in a Z-axis direction.

Inside the gantry 4, a radiation source 5 including a radiation tube 6 and a bowtie filter 7, and a detector 9 are disposed to face each other with the subject H interposed therebetween. The bowtie filter 7 optimizes an exposure dose by increasing the dose near a center and reducing the dose in the peripheral areas, in order to suppress the exposure dose in peripheral portions. Radiation emitted from the radiation tube 6 is shaped by the bowtie filter 7 into a beam shape suitable for a size of the subject H and is then emitted to the subject H. The detector 9 detects the radiation that has been transmitted through the subject H, and generates projection data corresponding to a photon count of the detected radiation. As one example, the detector 9 of the present embodiment is a photon-counting detector in which a plurality of detection elements 9P that detect photon energy, which is the energy of photons of incident radiation, are disposed in an arc shape centered on a focal point of the radiation tube 6. In the present embodiment, the detector 9 detects the photon energy of incident radiation by dividing the photon energy of incident radiation into a plurality of energy bins.

It should be noted that, in the present embodiment, X-rays are used as an example of the radiation, but the present disclosure is not limited to this, and γ-rays or the like may also be used.

The radiation source 5 and the detector 9 are rotated around the subject H by a rotation drive unit (not shown) of the gantry 4. As the radiation irradiation from the radiation source 5 and the detection of the radiation by the detector 9 are repeatedly performed in conjunction with the rotation of the radiation source 5 and the detector 9, data (hereinafter referred to as projection data) regarding the subject H is acquired for each radiation projection path. The projection data acquired by the detector 9 is output to the console 3 and stored in a storage of the console 3. A value of the data corresponding to each detection element 9P, which is a minimum unit of the projection data, is the count of photons detected by the detection element 9P. The projection data is acquired individually for each of the energy bins.

The dose of the radiation emitted from the radiation source 5, a rotation speed of the gantry 4, a relative movement speed between the gantry 4 and the patient table 8, and the like are set by the console 3 based on acquisition conditions for acquiring projection data, which are input by a user such as a technologist.

The console 3 of the present embodiment performs control related to acquisition of projection data, generation of medical images, control related to substance discrimination, and the like. The console 3 is an example of the information processing apparatus of the present disclosure.

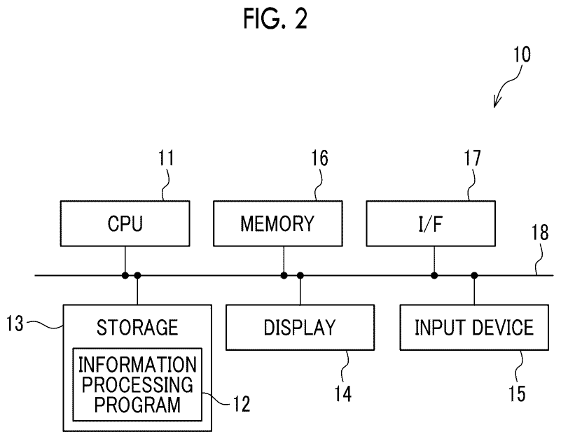

Next, the information processing apparatus according to the present embodiment will be described. First, a hardware configuration of the information processing apparatus according to the present embodiment will be described with reference to FIG. 2. As shown in FIG. 2, an information processing apparatus 10 is a computer, such as a workstation, a server computer, and a personal computer, and comprises a central processing unit (CPU) 11, a non-volatile storage 13, and a memory 16 as a temporary storage area.

In addition, the information processing apparatus 10 comprises a display 14, an input device 15, and an interface (I/F) 17. The CPU 11, the storage 13, the display 14, the input device 15, the memory 16, and the I/F 17 are connected to a bus 18. The CPU 11 is an example of a processor in the present disclosure.

The storage 13 is implemented using a hard disk drive (HDD), a solid-state drive (SSD), a flash memory, or the like. An information processing program 12 installed in the information processing apparatus 10 is stored in the storage 13 as a storage medium. The CPU 11 reads the information processing program 12 from the storage 13, loads the information processing program 12 into the memory 16, and executes the loaded information processing program 12.

The display 14 is a device that displays various screens, and is, for example, a liquid crystal display or an electro luminescence (EL) display.

The input device 15 is used by the user to input scan conditions for acquiring projection data, instructions related to generation, display, and the like of images, various kinds of information, and the like. Examples of the input device 15 include various switches, buttons, a touch panel, a touch pen, a keyboard, a mouse, and the like. The display 14 and the input device 15 may be integrated into a touch panel display.

The I/F 17 performs communication of various kinds of information with the rotation drive unit (not shown) of the gantry 4, the radiation source 5, and the detector 9 via wired communication or wireless communication.

The information processing program 12 is stored in a storage device of a server computer connected to a network or in a network storage in a state accessible from the outside and is downloaded to and installed in a computer that constitutes the information processing apparatus 10 in response to a request. Alternatively, the information processing program 12 is distributed by being recorded on a recording medium such as a digital versatile disc (DVD) or a compact disc read-only memory (CD-ROM), and is installed in a computer that constitutes the information processing apparatus 10 from the recording medium.

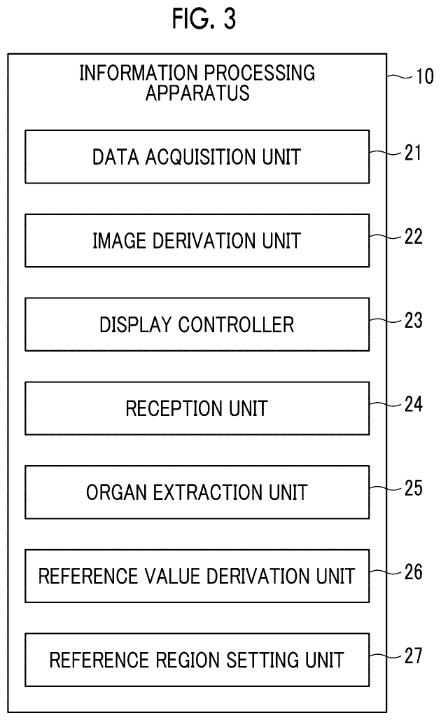

Next, a functional configuration of the information processing apparatus according to the present embodiment will be described. FIG. 3 is a diagram showing the functional configuration of the information processing apparatus according to the present embodiment. As shown in FIG. 3, the information processing apparatus 10 comprises a data acquisition unit 21, an image derivation unit 22, a display controller 23, a reception unit 24, an organ extraction unit 25, a reference value derivation unit 26, and a reference region setting unit 27. The CPU 11 executes the information processing program 12 to function as the data acquisition unit 21, the image derivation unit 22, the display controller 23, the reception unit 24, the organ extraction unit 25, the reference value derivation unit 26, and the reference region setting unit 27.

The data acquisition unit 21 acquires the projection data from the CT apparatus 2 via the I/F 17. For example, in a case in which four energy bins are set in the detector 9, the data acquisition unit 21 acquires the projection data for each of the four energy bins.

The image derivation unit 22 derives a linear attenuation coefficient image for each energy bin by performing reconstruction processing on the projection data acquired by the data acquisition unit 21 for each energy bin. Then, the substance discrimination image in which the substances are discriminated is derived using the linear attenuation coefficient image. In the present embodiment, the image derivation unit 22 derives a virtual monochromatic image, which is an image captured at a single energy, by performing weighted combination of the linear attenuation coefficient images at different energy levels. As the energy level of the virtual monochromatic image, for example, 70 keV can be used as a tube voltage, but the present disclosure is not limited to this. The virtual monochromatic image includes a plurality of tomographic images representing each of a plurality of tomographic planes of the subject H. The virtual monochromatic image is an example of the substance discrimination image in the present disclosure.

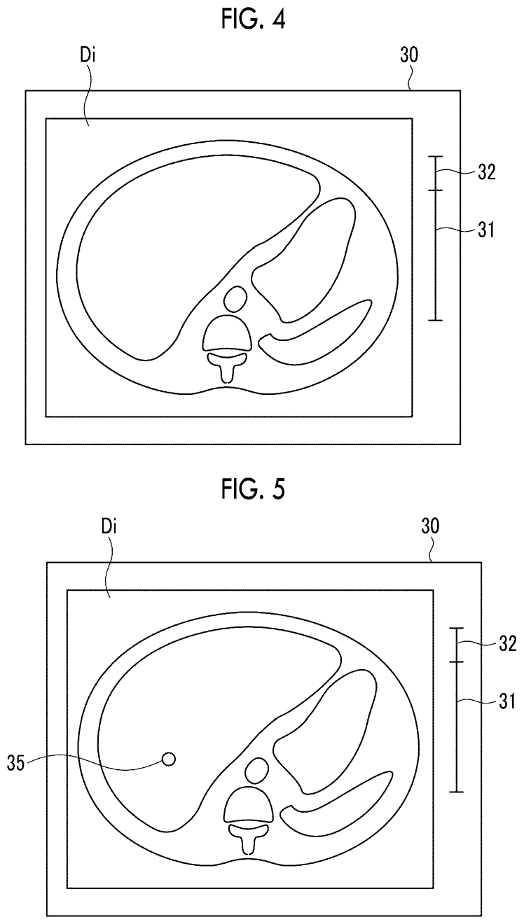

The display controller 23 displays the virtual monochromatic image on the display 14. FIG. 4 is a diagram showing the virtual monochromatic image displayed on the display 14. As shown in FIG. 4, a tomographic image Di (i=1 to n, n is the number of tomographic images) of one tomographic plane included in the virtual monochromatic image is displayed on a display screen 30 of the display 14. A plurality of the tomographic images may be simultaneously displayed on the display screen 30. A scale 31 for indicating the position of the tomographic plane of the displayed tomographic image Di is displayed on the display screen 30. The scale 31 includes a bar 32 indicating the position of the tomographic plane, and the position of the tomographic plane can be specified by the position of the bar 32 in the total length of the scale 31. The operator can switch the displayed tomographic image Di by operating the input device 15.

The operator who is an radiologist switches and displays the tomographic image Di to designate a region of interest that is a candidate for an abnormal shadow included in the tomographic image Di. For example, as shown in FIG. 5, the region of interest is designated by surrounding the region of interest with a circular mark 35. The reception unit 24 receives the designation of the region of interest by the operator.

The organ extraction unit 25 extracts the organ in which the operator designates the region of interest from the virtual monochromatic image. In the present embodiment, the organ extraction unit 25 extracts the organ from the virtual monochromatic image by using an extraction model that has been subjected to machine learning to extract the organ from the input virtual monochromatic image. In the present embodiment, the region of interest is designated in the liver in the tomographic image Di. Therefore, the organ extraction unit 25 extracts a region of the liver from the virtual monochromatic image. The liver is present in the plurality of tomographic images in the virtual monochromatic image. Therefore, the organ extraction unit 25 extracts the region of the liver from all the tomographic images including the liver.

The reference value derivation unit 26 derives the reference value for comparison with the region of interest in a case of performing the image diagnosis in the organ extracted by the organ extraction unit 25. In the present embodiment, the reference value derivation unit 26 derives an average value of the signal values (pixel values of the virtual monochromatic image) in the liver extracted by the organ extraction unit 25 as the reference value. A mode value may be used as the reference value instead of the average value.

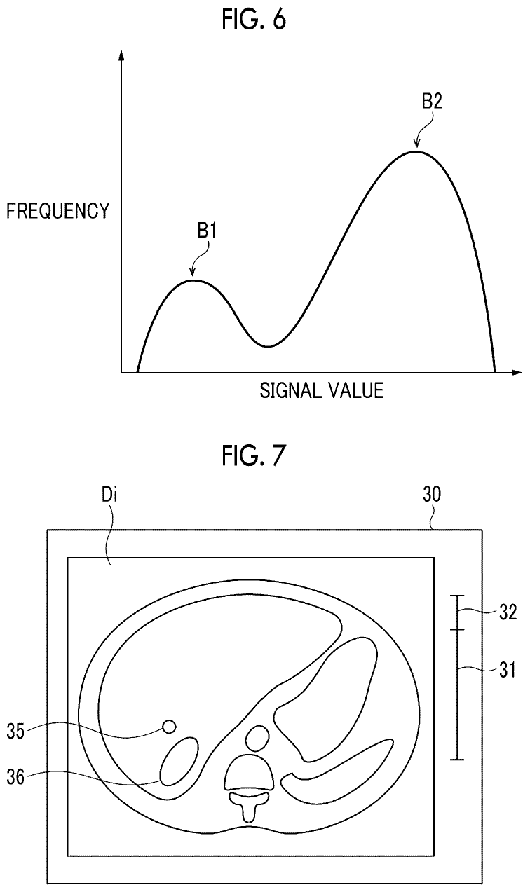

On the other hand, in a case where the histogram of the signal value of the virtual monochromatic image in the organ is obtained, a plurality of distributions of the signal values may appear. FIG. 6 is a diagram showing a histogram of a signal value of the virtual monochromatic image in an organ. In FIG. 6, the horizontal axis is the signal value, and the vertical axis is the frequency. In FIG. 6, two distributions B1 and B2 appear. The reference value derivation unit 26 may obtain the histogram of the signal value in the extracted organ and derive the average value or the mode value in the maximum distribution (in FIG. 6, the distribution B2) of the histogram as the reference value.

The reference region setting unit 27 sets the reference region in a region having the reference value in the plurality of tomographic images included in the virtual monochromatic image. In a case where a plurality of reference regions having the reference value are present, all of the reference regions may be set as the reference region, but only one reference region such as the reference region having the largest size or the reference region included in the tomographic image in which the region of interest is designated may be set.

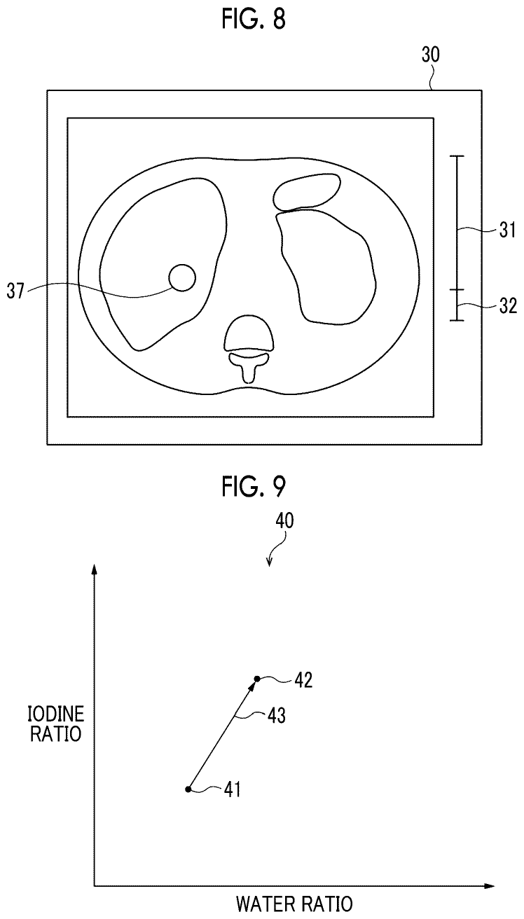

In a case where the reference region is set, the display controller 23 displays the reference region in the tomographic image in a distinguishable manner from other regions. In the present embodiment, the reference region is displayed in a distinguishable manner from other regions by assigning a mark to the reference region set in the tomographic image. FIG. 7 is a diagram showing a display screen of the tomographic image to which the mark is assigned to the reference region. As shown in FIG. 7, in addition to the mark 35 of the designated region of interest, a mark 36 is assigned to the reference region in the tomographic image Di displayed on the display screen 30. The reference region may be set in a tomographic image other than the tomographic image in which the region of interest is designated. In this case, as shown in FIG. 8, the tomographic image to which the mark 37 is assigned to the reference region is displayed by switching the tomographic image to be displayed. In addition, in FIGS. 7 and 8, the mark is assigned to surround the reference region, but a mark such as an arrow indicating the reference region may be assigned.

The diagnosis using the region of interest and the reference region designated in this way is performed, for example, as follows. First, a base substance image is derived using the linear attenuation coefficient image derived by the image derivation unit 22 and the linear attenuation coefficient corresponding to a predetermined base substance. As the predetermined base substance, for example, water and iodine are used, and the base substance image for water and the base substance image for iodine are derived. Further, a scatter diagram with water and iodine, which are the base substances, as axes is derived. Here, the pixel value of the region of interest in the virtual monochromatic image can be represented by the two values of the concentration of water and the concentration of iodine in the scatter diagram. Further, the reference value can also be represented by the two values of the concentration of water and the concentration of iodine in the scatter diagram.

Therefore, the pixel value of the region of interest and the reference value are plotted on the scatter diagram. FIG. 9 is a diagram showing the scatter diagram in which the pixel value of the region of interest and the reference value are plotted. In a scatter diagram 40 shown in FIG. 9, the horizontal axis indicates a water ratio (base substance concentration) that is a presence ratio of water to iodine, and the vertical axis indicates an iodine ratio (base substance concentration) that is a presence ratio of iodine to water. The horizontal axis is a water ratio axis, and the vertical axis is an iodine ratio axis. In the diagnosis, it is determined whether the region of interest is benign or malignant based on a direction (arrow 43) of the plot 42 of the region of interest with respect to the plot 41 of the reference region.

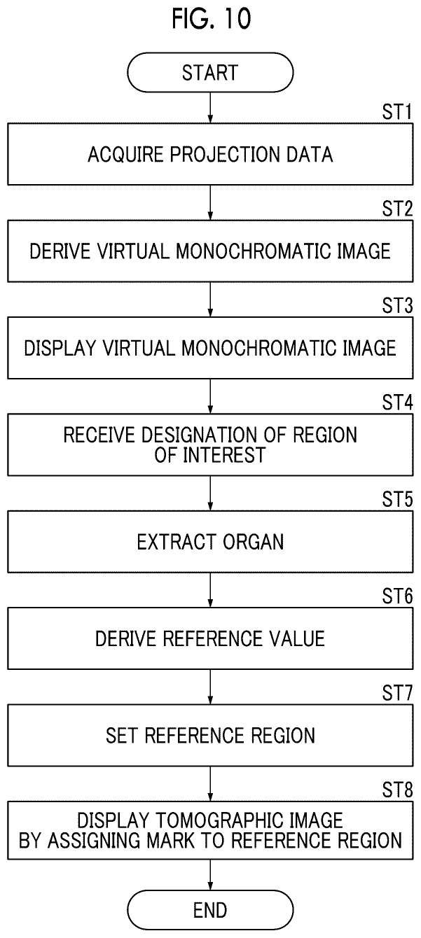

Next, processing performed in the present embodiment will be described. FIG. 10 is a flowchart showing the processing performed in the present embodiment. The data acquisition unit 21 acquires the projection data for each energy bin from the CT apparatus 2 (step ST1), and the image derivation unit 22 derives the linear attenuation coefficient image for each energy bin by reconstructing the projection data, and further derives the virtual monochromatic image (step ST2).

The display controller 23 displays the virtual monochromatic image on the display 14 (step ST3), and the reception unit 24 receives the designation of the region of interest by the operator (step ST4). The organ extraction unit 25 extracts the organ in which the operator designates the region of interest from the virtual monochromatic image (step ST5). The reference value derivation unit 26 derives the reference value for comparison with the region of interest in the organ extracted by the organ extraction unit 25 (step ST6). The reference region setting unit 27 sets the region having the reference value in the tomographic image included in the virtual monochromatic image as the reference region (step ST7). In a case where the reference region is set, the display controller 23 displays the tomographic image by assigning the mark to the reference region (step ST8), and the processing ends.

As described above, in the present embodiment, the organ in which the region of interest is designated is extracted from the virtual monochromatic image, and the reference value for comparison with the region of interest is derived in the extracted organ. Therefore, the operator can perform the image diagnosis by designating only the region of interest without designating the reference region in the displayed tomographic image. Therefore, the burden on the operator who designates the reference region in a case of performing the image diagnosis can be reduced.

In addition, by setting the reference region having the reference value in the tomographic image and displaying the reference region in a distinguishable manner from other regions by assigning the mark to the set reference region or the like, it is possible to easily recognize a position at which the reference region is set in the organ in which the region of interest is set.

In the above-described embodiment, the virtual monochromatic image is derived as the substance discrimination image, but the present disclosure is not limited to this. A substance discrimination image of a type different from the virtual monochromatic image, such as an electron density image, an effective atomic number image, and a specific substance image (iodine map), may be used. In addition, a plurality of types of substance discrimination images may be derived. Here, although the abnormality may not be observed in the virtual monochromatic image, the abnormality may be observed in the substance discrimination image of another type. Therefore, the reference region may be set using the virtual monochromatic image, and the abnormal region in which the abnormality is observed in the substance discrimination image of another type may be removed from the reference region set in the virtual monochromatic image. In this case, the reference region from which the abnormal region is removed may be used for the image diagnosis.

In the above-described embodiment, water and iodine are used as the base substances for deriving the scatter diagram used for the image diagnosis, but the present disclosure is not limited to this, and any substance can be used as the base substance.

In addition, in the above-described embodiment, the PCCT device is used as the CT apparatus 2, but the present disclosure is not limited to this. It is needless to say that a DECT device may be used.

In the present embodiment, each process of the information processing apparatus 10 is executed by any computer. In addition, any computer may execute these processes by means of a processor as hardware, a program as software, or a combination thereof. In that case, the processor is configured to execute various types of processing in the information processing apparatus 10 of the present embodiment in cooperation with the program and can function as each unit or each means in the present embodiment. Additionally, the execution order of the process by the processor is not limited to the order described above and may be changed as appropriate. Any computer may be a general-purpose computer, a computer for a specific application, a workstation, or another system capable of executing each process.

The processor may be configured using one or more pieces of hardware, and the type of hardware is not limited. For example, the processor may be configured using hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphic processing unit (GPU), or a neural processing unit (NPU). In addition, the type of hardware may be a combination of different types of hardware. In a case where a plurality of pieces of hardware are configured to execute one or more processes of a certain processor, the plurality of pieces of hardware may be present in devices physically separated from each other or may be present in the same device. Additionally, in any of the embodiments, the order of each process by the processor is not limited to the order described above and may be changed as appropriate. The hardware is configured using an electrical circuit (circuitry) in which circuit elements, such as semiconductor elements, are combined, or the like.

Further, the program may be software, such as firmware or a microcode. In addition, the program may be, for example, a program module group, and each function thereof may be implemented by a processor configured to execute the corresponding function. The program may be a program code or a plurality of code segments stored in one or more non-transitory computer-readable media (for example, storage media, other storages, or the like). The program may be distributed and stored across a plurality of non-transitory computer-readable media that are present in devices physically separated from each other. The program code or code segments may represent any combination of procedures, functions, subprograms, routines, subroutines, modules, software packages, classes, or commands, data structures, or program statements. The program code or the code segment may be connected to another code segment or a hardware circuit by transmitting and receiving information, data, an argument, a parameter, or contents of a memory.

Additionally, in the above-described embodiment, an aspect has been described in which the information processing program 12 is stored (installed) in advance in the storage 13, but the present disclosure is not limited to this aspect. The information processing program 12 may be provided in a form recorded on a recording medium, such as a compact disc read-only memory (CD-ROM), a digital versatile disc read-only memory (DVD-ROM), and a universal serial bus (USB) memory. Alternatively, the information processing program 12 may be provided in a form that can be downloaded from an external device via a network.

The technology of the present disclosure extends to all kinds of program products. The program product includes all forms of products for providing a program. For example, the program product includes a program provided through a network such as the Internet, a non-transitory computer-readable recording medium, such as a CD-ROM, a DVD, and a USB memory in which the program is stored, and the like.

Hereinafter, the supplementary claims of the present disclosure will be described.

### Supplementary Claim 1

An information processing apparatus comprising:
a processor,
wherein the processor is configured to:
display at least one tomographic image of a substance discrimination image including a plurality of tomographic images derived by substance discrimination;
receive designation of a region of interest in the displayed tomographic image;
extract an organ in which the region of interest is designated from the substance discrimination image; and
derive a reference value for comparison with the region of interest in the extracted organ.

### Supplementary Claim 2

The information processing apparatus according to supplementary claim 1,
wherein the processor is configured to:
set a reference region in a region having the reference value in the plurality of tomographic images; and
display the tomographic image in which the reference region is set in a distinguishable manner from other regions.

### Supplementary Claim 3

The information processing apparatus according to supplementary claim 2,
wherein the processor is configured to:
determine whether an abnormality is included in the reference region by referring to at least one other substance discrimination image of a type different from the substance discrimination image; and
set the reference region excluding an abnormal region that includes the abnormality, in a case where the abnormality is determined to be included.

### Supplementary Claim 4

The information processing apparatus according to any one of supplementary claims to 3, wherein the processor is configured to derive, as the reference value, any one of an average value of signal values in the extracted organ in the plurality of tomographic images, a mode value of the signal values, or an average value or a mode value in a maximum distribution in a case where the signal values in the organ are separated into a plurality of distributions.

### Supplementary Claim 5

The information processing apparatus according to any one of supplementary claims to 4, wherein the reference value is a two-dimensional value defined by a signal value of a first substance and a signal value of a second substance that are subjected to the substance discrimination.

### Supplementary Claim 6

An information processing method comprising:
via a computer,
displaying at least one tomographic image of a substance discrimination image including a plurality of tomographic images derived by substance discrimination;
receiving designation of a region of interest in the displayed tomographic image;
extracting an organ in which the region of interest is designated from the substance discrimination image; and
deriving a reference value for comparison with the region of interest in the extracted organ.

### Supplementary Claim 7

An information processing program causing a computer to execute:
a procedure of displaying at least one tomographic image of a substance discrimination image including a plurality of tomographic images derived by substance discrimination;
a procedure of receiving designation of a region of interest in the displayed tomographic image;
a procedure of extracting an organ in which the region of interest is designated from the substance discrimination image; and
a procedure of deriving a reference value for comparison with the region of interest in the extracted organ.

What is claimed is:

1. An information processing apparatus comprising:
a processor,
wherein the processor is configured to:
display at least one tomographic image of a substance discrimination image including a plurality of tomographic images derived by substance discrimination;
receive designation of a region of interest in the displayed tomographic image;
extract an organ in which the region of interest is designated from the substance discrimination image; and
derive a reference value for comparison with the region of interest in the extracted organ.

2. The information processing apparatus according to claim 1,
wherein the processor is configured to:
set a reference region in a region having the reference value in the plurality of tomographic images; and
display the tomographic image in which the reference region is set in a distinguishable manner from other regions.

3. The information processing apparatus according to claim 2,
wherein the processor is configured to:
determine whether an abnormality is included in the reference region by referring to at least one other substance discrimination image of a type different from the substance discrimination image; and
set the reference region excluding an abnormal region that includes the abnormality, in a case where the abnormality is determined to be included.

4. The information processing apparatus according to claim 1
wherein the processor is configured to derive, as the reference value, any one of an average value of signal values in the extracted organ in the plurality of tomographic images, a mode value of the signal values, or an average value or a mode value in a maximum distribution in a case where the signal values in the organ are separated into a plurality of distributions.

5. The information processing apparatus according to claim 2
wherein the processor is configured to derive, as the reference value, any one of an average value of signal values in the extracted organ in the plurality of tomographic images, a mode value of the signal values, or an average value or a mode value in a maximum distribution in a case where the signal values in the organ are separated into a plurality of distributions.

6. The information processing apparatus according to claim 1,
wherein the reference value is a two-dimensional value defined by a signal value of a first substance and a signal value of a second substance that are subjected to the substance discrimination.

7. The information processing apparatus according to claim 2,
wherein the reference value is a two-dimensional value defined by a signal value of a first substance and a signal value of a second substance that are subjected to the substance discrimination.

8. An information processing method comprising:
via a computer,
displaying at least one tomographic image of a substance discrimination image including a plurality of tomographic images derived by substance discrimination;
receiving designation of a region of interest in the displayed tomographic image;
extracting an organ in which the region of interest is designated from the substance discrimination image; and
deriving a reference value for comparison with the region of interest in the extracted organ.

9. A non-transitory computer-readable storage medium that stores an information processing program causing a computer to execute:
a procedure of displaying at least one tomographic image of a substance discrimination image including a plurality of tomographic images derived by substance discrimination;
a procedure of receiving designation of a region of interest in the displayed tomographic image;
a procedure of extracting an organ in which the region of interest is designated from the substance discrimination image; and
a procedure of deriving a reference value for comparison with the region of interest in the extracted organ.
